(19) United States
(12) Patent Application Publication
(10) Pub. No.: US 2010/0262926 A1
(43) Pub. Date: Oct. 14, 2010

(54) CUSTOMIZING RECURRING CALENDAR EVENTS

(76) Inventors: Pawan Gupta, Holden, MA (US); Samir J. Patel, Billerica, MA (US)

Correspondence Address: HOLLAND & KNIGHT, 10 ST. JAMES AVENUE, BOSTON, MA, 02116-3889, US

(21) Appl. No.: 12/422,540

(22) Filed: Apr. 13, 2009

(51) Int. Cl. G06Q 10/00; G06F 3/048

(52) U.S. Cl. 715/764; 705/9

(57) ABSTRACT

A request to create a repeating meeting event on a calendar and scheduling computer system is received. One or more instances of individual meetings of the repeating meeting event are listed. A request to modify at least one of the one or more instances of individual meetings is received. A modified repeating meeting event including one or more modified and unmodified instances of individual meetings is created. The modified repeating meeting event is sent to one or more recipients from the calendar and scheduling computer system.

### BACKGROUND OF THE INVENTION

This disclosure relates to calendars and scheduling, more particularly, to computer systems, computer program products, and methods for creating repeated calendar meetings.

Many computer users today use calendar programs. Calendar programs are especially popular in the workplace because they can help coordinate meetings. For example, a meeting chair may set up a meeting by creating a meeting event in their calendar. The chair may invite others to join the meeting by adding them to the meeting. Once added, the calendar program may send the invitees a meeting request—via email or some other method—that the invitee can accept or decline. Typically, if the invitee accepts the meeting request, the meeting will be added to the invitee's calendar.

A meeting chair may wish to set up a recurring meeting. A recurring meeting is a meeting that occurs more than once. It may occur on a regular basis (such as every Friday at 10:00), or it may occur at irregular times depending on the needs of the meeting chair.

Some calendar programs allow the chair to automatically set up a recurring meeting and send a single invitation that invites attendees to all occurrences of the meeting. For example, a meeting chair may wish to set up a meeting that occurs every Tuesday and Friday at 11:00 for five weeks. In this case, the calendar program may have a feature that allows the chair to set up a recurring meeting for those days and times. Instead of sending multiple invitations to each attendee, the calendar program may send a single invitation that adds all the occurrences of the meeting to each invitee's calendar.

However, the meeting chair may require more flexibility and may need to customize or reschedule individual occurrences of the meeting. Meeting conflicts can occur that require rescheduling or changing a meeting occurrence. For example, an important attendee may not be able to attend one particular meeting or the meeting room may not be available during one of the meeting occurrences. Alternatively, the chair may wish to schedule the meeting for different times on different days: 11:00 on Tuesdays and 10:00 on Fridays, for example. Current calendar programs may not provide the ability to customize individual occurrences of repeating meetings and the meeting chair may be forced to send multiple meeting requests, or send a recurring meeting request then customize individual instances of the meeting once they are already on the invitees' calendars.

### BRIEF SUMMARY OF THE INVENTION

In an embodiment, a method for sending modified repeating meetings events includes receiving a request to create a repeating meeting event on a calendar and scheduling computer system. One or more instances of individual meetings of the repeating meeting event are listed. A request to modify at least one of the one or more instances of individual meetings is received. A modified repeating meeting event including one or more modified and unmodified instances of individual meetings is created. The modified repeating meeting event is sent to one or more recipients from the calendar and scheduling computer system.

One or more of the following features may be included. The method may display a customization button on a computer display, wherein activation of the customization button may trigger the listing of the one or more instances of individual meetings. The request to modify at least one of the one or more instances of individual meetings may include a request to modify one or more of a date and time of the one or more instances of individual meetings. The request to modify at least one of the one or more instances of individual meetings may also include a request to modify a resource associated with the one or more instances of individual meetings.

The method may also display a list of available resources associated with at least one of the instances of individual meetings, thus allowing a user to select one or more available resources from the list. Listing the one or more instances of individual meetings may include displaying the one or more instances of individual meetings on a display, thus allowing a user to select one or more of the instances of individual meetings for modification.

In another embodiment, a computer program product resides on a computer readable medium. The computer program product includes instructions which, when executed by a processor, cause the processor to perform operations including receiving a request to create a repeating meeting event on a calendar and scheduling computer system. One or more instances of individual meetings of the repeating meeting event are listed. A request to modify at least one of the one or more instances of individual meetings is received. A modified repeating meeting event including one or more modified and unmodified instances of individual meetings is created. The modified repeating meeting event is sent to one or more recipients from the calendar and scheduling computer system.

One or more of the following features may be included. The operations may cause the processor to display a customization button on a computer display, wherein activation of the customization button may trigger the listing of the one or more instances of individual meetings. The request to modify at least one of the one or more instances of individual meetings may include a request to modify one or more of a date and time of the one or more instances of individual meetings. The request to modify at least one of the one or more instances of individual meetings may also include a request to modify a resource associated with the one or more instances of individual meetings.

The operations may also cause the processor to display a list of available resources associated with at least one of the instances of individual meetings, thus allowing a user to select one or more available resources from the list. Listing the one or more instances of individual meetings may include displaying the one or more instances of individual meetings on a display, thus allowing a user to select one or more of the instances of individual meetings for modification.

In another embodiment, a system includes one or more processors, one or more memories, and one or more software instruction sets stored on the one or more memories, which, when executed by the one or more processors, perform operations including receiving a request to create a repeating meeting event on a calendar and scheduling computer system. One or more instances of individual meetings of the repeating meeting event is listed. A request to modify at least one of the one or more instances of individual meetings is received. A modified repeating meeting event including one or more modified and unmodified instances of individual meetings is created. The modified repeating meeting event is sent to one or more recipients from the calendar and scheduling computer system.

One or more of the following features may be included. The operations may display a customization button on a computer display, wherein activation of the customization button may trigger the listing of the one or more instances of individual meetings. The request to modify at least one of the one or more instances of individual meetings may include a request to modify one or more of a date and time of the one or more instances of individual meetings. The request to modify at least one of the one or more instances of individual meetings may also include a request to modify a resource associated with the one or more instances of individual meetings.

The operations may also display a list of available resources associated with at least one of the instances of individual meetings, thus allowing a user to select one or more available resources from the list. Listing the one or more instances of individual meetings may include displaying the one or more instances of individual meetings on a display, thus allowing a user to select one or more of the instances of individual meetings for modification.

The details of one or more implementations are set forth in the accompanying drawings and the description below. Other features and advantages will become apparent from the description, the drawings, and the claims.

### BRIEF DESCRIPTION OF THE SEVERAL VIEWS OF THE DRAWINGS

FIG. 1 is diagrammatic view of a calendar scheduling process coupled to a distributed computing network.

FIG. 2 is a flowchart of the calendar scheduling process.

FIG. 3 is a graphical user interface that may provide repeated meeting features of the claimed method, computer program product, and system.

FIG. 4 is a graphical user interface that may provide meeting customizations features of the claimed method, computer program product, and system.

FIG. 5a is a list of individual meetings associated with a repeated meeting event.

FIG. 5b is a list of modified individual meetings associated with a repeated meeting event.

FIG. 6 is a user's calendar displaying the modified individual meetings associated with a repeated meeting event.

Like references in the drawings denote like elements.

### DETAILED DESCRIPTION OF THE INVENTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in one or more computer-readable (i.e., computer-usable) medium(s) having computer-usable program code embodied thereon.

Any combination of one or more computer-readable medium(s) may be utilized. The computer-readable medium may be a computer readable signal medium or a computer readable storage medium. A computer-readable storage medium may be, for example, but not limited to, an electronic, magnetic, optical, electromagnetic, infrared, or semiconductor system, apparatus, a device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. Note that the computer-readable storage medium could even be paper or another suitable medium upon which a program is printed, as the program can be electronically captured, via, for instance, optical scanning of the paper or other medium, then compiled, interpreted, or otherwise processed in a suitable manner, if necessary, and then stored in a computer memory. In the context of this document, a computer-readable storage medium may be any medium that can contain, or store a program for use by or in connection with an instruction execution system, apparatus, or device.

A computer readable signal medium may include a propagated data signal with computer-usable program code embodied therein, for example, in baseband or as part of a carrier wave. Such a propagated signal may take any of a variety of forms, including, but not limited to, electro-magnetic, optical, or any suitable combination thereof//, A computer readable signal medium may be any computer-readable medium that can contain, store, communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

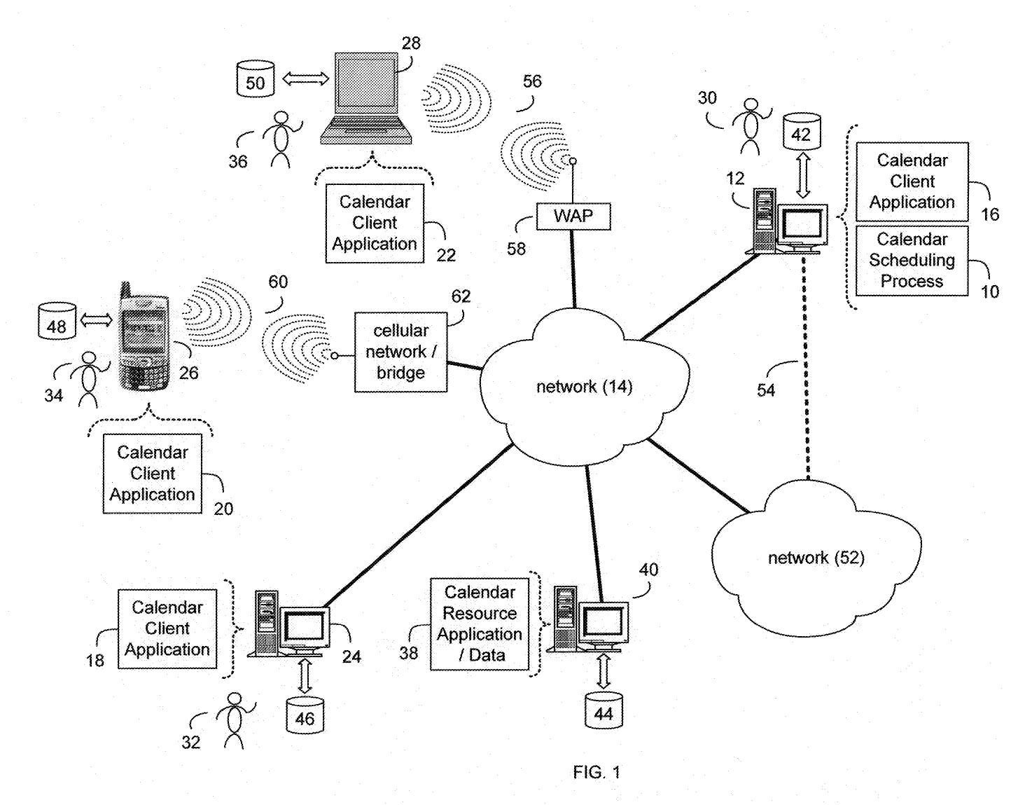

FIG. 1 depicts a computing infrastructure within which calendar scheduling process 10 may reside. Calendar scheduling process 10, for example, may reside on and may be executed by computer 12, which may be connected to network 14 (e.g., the Internet or a local area network). Examples of computer 12 may include, but are not limited to: a personal computer, a server computer, a series of server or personal computers, a mini computer, and a mainframe computer.

FIG. 1 also depicts calendar client applications 16, 18, 20, 22, which may reside on and may be executed by computer 12, desktop computer 24, personal digital assistant (“PDA”) 26, and laptop 28, respectively. Various electronic devices, including computer 12, desktop computer 24, personal digital assistant (“PDA”) 26, and laptop 28, may also be connected to network 14, as shown. Although not shown, calendar scheduling process 10 may also reside on one or more of the various electronic devices coupled to network 14.

Calendar client applications 16, 18, 20, 22 may be instances of an application used by meeting chair 30 and/or users 32, 34, 36 to manage schedules and meetings. Examples of calendar client application 16, 18, 20, 22 may include, but are not limited to, Lotus Notes® and Microsoft® Exchange® clients (Lotus Notes is a registered trademark of International Business Machines Corporation in the United States, other countries, or both. Microsoft and Exchange are registered trademarks of Microsoft Corporation in the United States, other countries, or both).

In addition, FIG. 1 depicts calendar server application 38 which may reside on and be executed by server computer 40. Calendar server application 38 may be a server application that assists and/or manages calendars and schedules for users of calendar client applications 16, 18, 20, 22. Calendar server application 38 may be, for example, a Lotus Notes server application or a Microsoft Exchange server application, although other calendar server applications may be used. Calendar server application 38 may also include a database for storing calendar and scheduling information, for example. Calendar server application may manage calendars and/or resources within the workplace.

As will be discussed below in greater detail, calendar scheduling process 10 may receive a request to create a repeating meeting event. Calendar scheduling process may list one or more instances of individual meetings of the repeating meeting event and may receive a request to modify at least one of the one or more instances of individual meetings. Calendar scheduling process may also modify the repeating meeting event including the modified and unmodified instances of individual meetings and send the modified repeating meeting event to one or more recipients of the meeting event.

Computer 12, server computer 40, desktop computer 24, PDA 26, and laptop computer 28 may run network operating systems, examples of which may include but are not limited to: Microsoft Windows XP® Server; Novell® Netware®; or Redhat® Linux®, for example (Windows XP is a registered trademark of Microsoft Corporation in the United States, other countries, or both; Novell and NetWare are registered trademarks of Novell Corporation in the United States, other countries, or both; Red Hat is a registered trademark of Red Hat Corporation in the United States, other countries, or both; and Linux is a registered trademark of Linus Torvalds in the United States, other countries, or both).

The instruction sets and subroutines of calendar scheduling process 10, which may include one or more software modules and one or more sets of software instructions, and which may be stored on storage device 42 coupled to computer 12, may be executed by one or more processors (not shown) and one or more memory architectures (not shown) incorporated into computer 12. Similarly, the instruction sets and subroutines of calendar server application 38, which may include one or more software modules and one or more sets of software instructions, and which may be stored on storage device 44 coupled to server computer 40, may be executed by one or more processors (not shown) and one or more memory architectures (not shown) incorporated into server computer 18. Calendar client applications 16, 18, 20, and 22 may also include one or more software modules and one or more sets of software instructions, which may be stored on storage devices 42, 46, 48, 50, and may be executed by the various electronic devices to which they are coupled, as shown in FIG. 1. Storage devices 42, 44, 46, 48, 50 may include but are not limited to: hard disk drives; solid state drives; tape drives; optical drives; RAID arrays; random access memory (RAM); and a read-only memory (ROM).

The instruction sets and subroutines of calendar scheduling process 10, calendar server application 38, and calendar client applications 16, 18, 20, 22 may be generated through the use of a compiler, such as the IBM XL compiler, the Visual Studio® compiler, or an assembler, for example (Visual Studio is a registered trademark of Microsoft Corporation in the United States, other countries, or both). The instruction set and subroutines may also be generated as scripts, such as JavaScript® scripts, or as other types of software code (Java and all Java-based trademarks and logos are trademarks of Sun Microsystems, Inc. in the United States, other countries, or both). In general, and as is known in the art, the instruction sets and subroutines of calendar scheduling process 10 and server application 16 may be generated via any method of generating instruction sets and subroutines that may be executed by a processor.

As mentioned, various client electronic devices may be coupled to network 14. Examples of client electronic devices may include, but are not limited to: computer 12, server computer 40, desktop computer 24, PDA 26, laptop 28, a data-enabled, cellular telephone (not shown), and a dedicated network device (not shown). One or more users (e.g., user 32, 34, 36 and meeting char 30) may access the various tools and applications, such as calendar scheduling process 10, calendar client applications 16, 18, 20, 22, or calendar server application 38 from any device connected to network 14 or directly from the device on which the tool or application resides.

Client electronic devices may be coupled directly to network 14, or may be indirectly coupled to network 14 through network 52. For example, computer 12 may be indirectly connect to network 14 through secondary network 52, as illustrated by phantom link line 54.

The various client electronic devices may be directly or indirectly coupled to network 14 (or network 52). For example, computer 12 is shown directly coupled to network 14 via a hardwired network connection. Laptop 28 is shown wirelessly coupled to network 14 via wireless communication channel 56 established between laptop 28 and wireless access point (i.e., WAP) 58, which is shown directly coupled to network 14. WAP 58 may be, for example, an IEEE 802.11a, 802.11b, 802.11g, Wi-Fi, and/or Bluetooth device that is capable of establishing wireless communication channel 32 between laptop 26 and WAP 34. PDA 26 is shown wirelessly coupled to network 14 via cellular communication channel 60 and cellular network/bridge 62, which is shown directly coupled to network 14.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

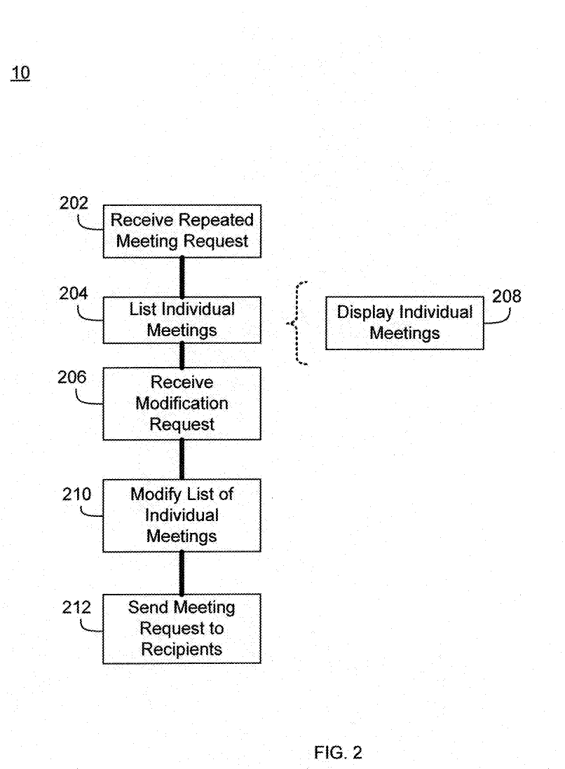

Referring to FIG. 2, calendar scheduling process 10 may receive 202 a request to create a repeating meeting event. Calendar scheduling process 10 may list 204 one or more instances of individual meetings of the repeating meeting event and may receive 206 a request to modify at least one of the one or more instances of individual meetings. Listing 204 the one or more instances of individual meetings may include displaying 208 the instances of individual meetings, thus allowing a user to select individual meetings for customization. Calendar scheduling process may also modify 210 the repeating meeting event by modifying 210 one or more instances of individual meetings associated with the repeating meeting event, and send 212 the modified repeating meeting event to one or more recipients of the meeting event.

Calendar scheduling process 10 may receive 202 a request to create a repeating meeting event. A repeating meeting event may be a meeting that recurs with a particular pattern. For example, a repeating meeting event may be a meeting that occurs once a week (e.g. every Tuesday), once a month, twice a week, twice a month, etc. Typically, calendar programs may have features that allow users to create repeating meeting events. A typical calendar program may, for example, provide a feature that allows a user to set up a recurring meeting rather than scheduling individual meetings for each meeting instance. The user may, for instance, set up a rule that dictates how the meeting is to be scheduled. For example, the user may set up a rule that creates a recurring meeting that consists of an individual meeting that repeats every Friday for three months. A user may create such a rule and calendar scheduling process 10 may receive 202 the request to create a repeating meeting event (i.e. the rule in the example above). Scheduling process 10 may then create a recurring meeting based on the request for the repeating meeting event.

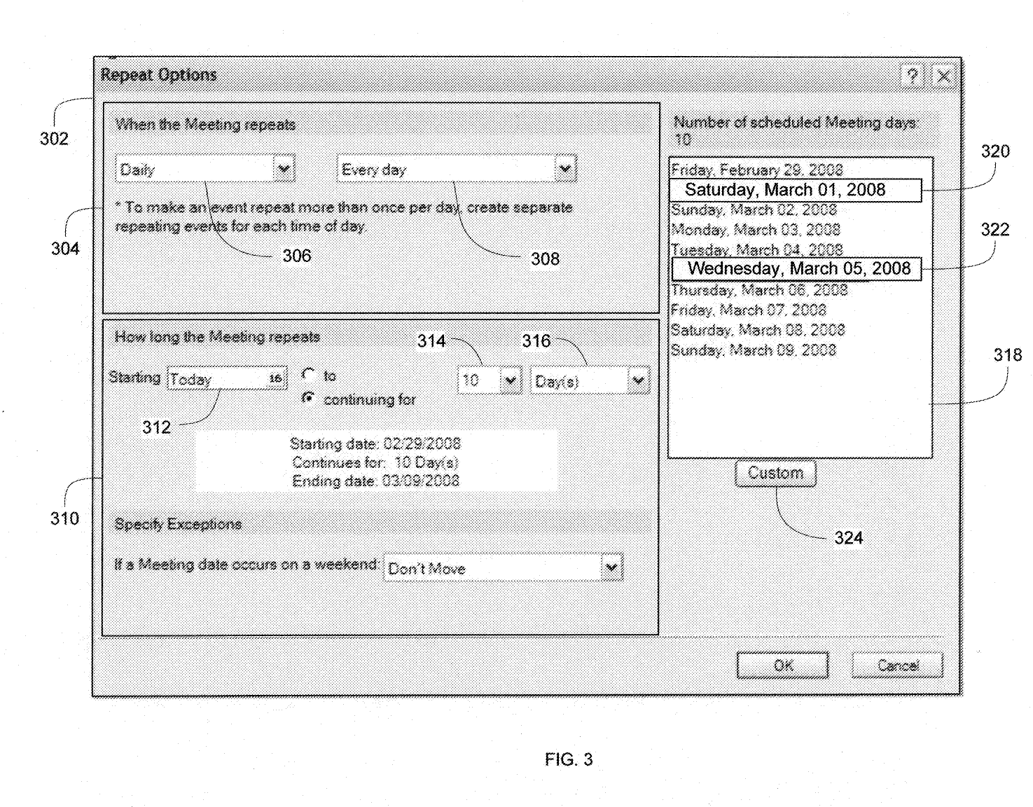

Turning to FIG. 3, sample dialog box 302 is shown that may be used to receive 202 a request for a repeating meeting event. Dialog box 302 includes box 304, where a user may enter options for a repeating meeting event. Drop down box 306 may include options such as “daily,” “weekly,” or “monthly,” for example, that indicate how frequently the repeating meeting event repeats. Drop down box 308 may include options such as “every day,” or “every Friday,” for example, that indicate when the repeated meeting should occur. Other options may be available. For example, a user may pick the time of day that the repeating meeting event occurs or may pick multiple days upon which the meeting occurs (such as every Tuesday and Friday), for example.

Dialog box 302 also includes box 310, which may include options for how long the meeting repeats. A user may choose, for example, the day upon which a repeating meeting event starts via drop down box 312 and the length of time the meeting lasts via drop down boxes 314, 316. In the example shown in FIG. 3, a user has chosen options for a ten-day repeating meeting event that occurs every day.

Once calendar scheduling process 10 receives 202 the request for the repeating meeting event, calendar scheduling process 10 may create a repeating meeting. For example, if calendar scheduling process receives 202 a request to create a meeting that recurs every Friday at 10:00 starting Friday, Mar. 13, 2009 and lasting for three weeks, calendar scheduling process may create a meeting event consisting of three individual meetings: the first for Mar. 13, 2009, the second for Mar. 20, 2009, and the third for Mar. 27, 2009.

When calendar scheduling process 10 creates the repeating meeting, calendar scheduling process 10 may list 204 the individual meetings associated with the repeating meeting. In the example above, calendar scheduling process 10 may list 204 the three meetings occurring on Mar. 13, 2009; Mar. 20, 2009; and Mar. 27, 2009. Calendar scheduling process 10 may list 204 the meetings by creating a list and storing the list on a computer readable medium, i.e., by creating a list in memory or in a file on a hard drive, for example.

Calendar scheduling process 10 may also display 208 the list of individual meetings associated with the repeating meeting to a user of calendar scheduling process 10. Displaying 208 the list may allow the user to review the list and determine if any individual meetings associated with the recurring meeting may need to be modified. For example, dialog box 302 may include box 318, which displays 208 a list of individual meetings associated with a repeating meeting event. In this example, box 318 displays ten individual meetings corresponding to the user options entered in box 304 and box 310.

In some cases, one or more of the individual meetings associated with a repeating meeting event may have a conflict. For example, an important attendee might not be able to attend one of the meetings, or a meeting room may not be available during one of the individual meetings. Where a conflict occurs, meeting chair 30 may wish to customize or modify some, but not all, of the individual meetings. In this case, meeting chair 30 may select one or more individual meetings to customize, as shown in FIG. 3 where a user has selected individual meetings 320, 322.

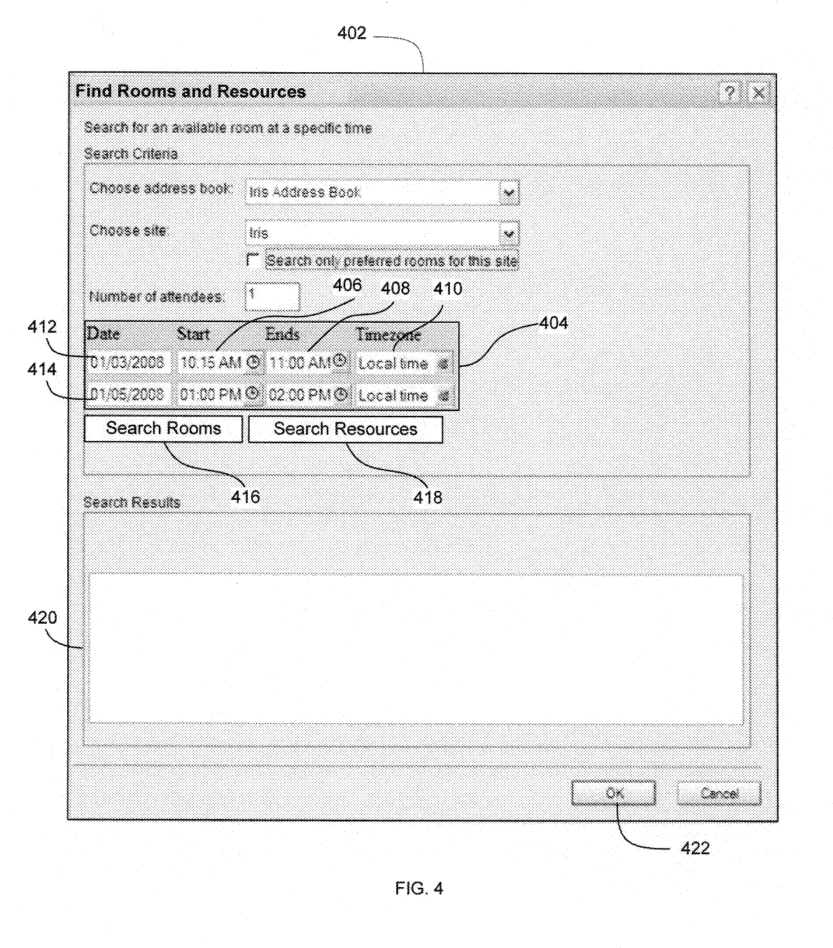

Once meeting chair 30 selects one or more individual meetings for customization, calendar scheduling process 10 may provide a mechanism or method for customizing the individual meetings. For example, calendar scheduling process 10 may provide customization button 324 which may allow a user to make changes to or customize individual meetings from the list. In one embodiment, activation of customize button 324 may cause calendar scheduling process 10 to display dialog box 402 (in FIG. 4), which may provide options so that meeting chair 30 may customize individual meetings from the list.

Dialog box 402 may include features for customizing individual meetings. If a user selects two meetings for customization, dialog box 402 may list 204 those two meetings in list box 404, for example. Meeting chair 30 may then customize one or more of the meetings chosen for customization. Meeting chair 30 may change the time of an individual meeting using drop down boxes 406, 408, 410, for example. Meeting chair 30 may also change the date of an individual meeting via box 412 or 414. If a room or resource (such as a projector) is not available for an individual meeting, meeting chair 30 may search for rooms via search rooms button 416 or search for resources via search resources button 418. These buttons may activate a search process that finds and lists available rooms and/or resources in search results box 420. Meeting chair 30 may then customize one or more individual meetings by associating the available resources with and/or adding the available resources to one or more of the individual meetings.

Once meeting chair 30 customizes individual meetings, calendar scheduling process 10 may receive 206 a request to customize the repeating meeting event. The request may include data and/or information relating to and describing the changes meeting chair 30 made to individual meetings of the repeating meeting event. For example, if meeting chair 30 changes the date of one of the individual meetings, meeting chair 30 may press OK button 422 and calendar scheduling process 10 may receive 206 the request to change the date of one of the individual meetings. In the example described above, calendar scheduling process 10 may receive 206 a request to modify individual meetings via activation of a graphical user interface (“GUI”). However, as one skilled in the art will recognize, calendar scheduling process 10 may receive 206 the request to modify individual meetings from any source, including a GUI, and an automated process that checks for meeting conflicts without user interaction, for example.

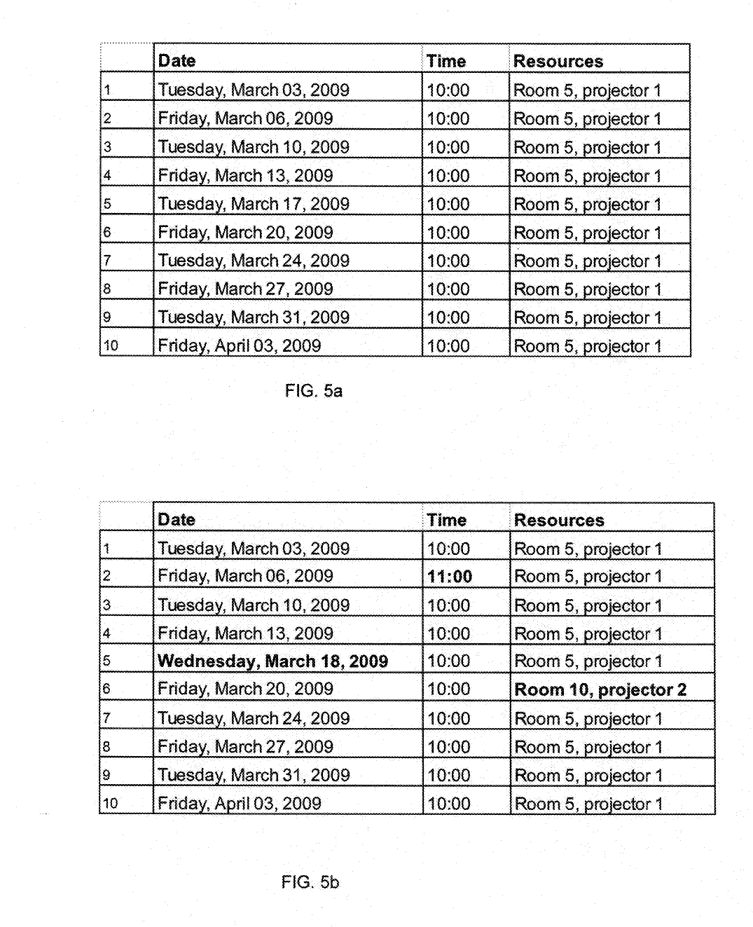

If calendar scheduling process 10 receives 206 a request to modify one or more individual meetings, scheduling process 10 may modify the list of individual meetings associated with the repeating meeting event. FIG. 5a may show an example of a list of individual meetings for a repeating meeting event that occurs every Tuesday and Friday at 10:00. In the example, the repeating meeting event may begin on Mar. 3, 2009, and repeat for five weeks, ending on Apr. 3, 2009. Each meeting may be scheduled in Room 5 and may use projector 1, as shown. Accordingly, calendar scheduling process may list 204 the individual meetings associated with the repeating meeting event, like the list shown in FIG. 5a.

However, there may be conflicts with some of the individual meetings. In this example there may be three conflicts: an important attendee may not be able to attend the individual meeting on line 2, the individual meeting on line 5 may fall on a holiday (St. Patrick's Day), and room 5 and projector 1 may be unavailable at the time of the individual meeting on line 6. Accordingly, in this example, meeting chair 30 may wish to customize those three meetings to avoid the conflicts. Meeting chair 30 may, for example, change the individual meeting on line 2 to 11:00, so that the important attendee can attend; change the individual meeting on line 5 to Wednesday the 18th so that it avoids the holiday; and change the resources for the individual meeting on line 6 to room 10 and projector 2, which may be available during the time of the meeting on line 6. Accordingly, calendar scheduling process 10 may receive 206 a request to modify these three individual meetings, and may modify 210 the list of individual meetings to reflect the changes.

FIG. 5b shows a list of individual meetings that includes the modifications discussed above. Line 2 in FIG. 5b shows the individual meeting where the time has been changed from 10:00 to 11:00, so that the important attendee can attend, for example. Line 5 in FIG. 5b shows the individual meeting rescheduled for Mar. 18, 2009, so as to avoid the holiday. Line 6 in FIG. 5b shows the individual meeting where the associated resources have been changed to room 10 and projector 2. Although this example illustrates changes to dates, times, and resources, calendar scheduling process 10 may make and receive other changes and modifications. These other changes may include attendees, max number of attendees, min number of attendees, catering information, budget information, or any other information relating to an individual meeting and/or a repeating meeting event.

Calendar scheduling process 10 may also send 212 a meeting request, which may include any modifications to any individual meetings within the repeated meeting event, to a meeting request recipient (e.g. users 32, 34, 36). Calendar scheduling process 10 may send 212 the meeting request by sending a message to the meeting request recipients, by adding the meeting directly to the meeting recipients' calendars, or by any means of sending a meeting request to the recipient, such that the repeated meeting event and any modifications is added to the recipients' calendars.

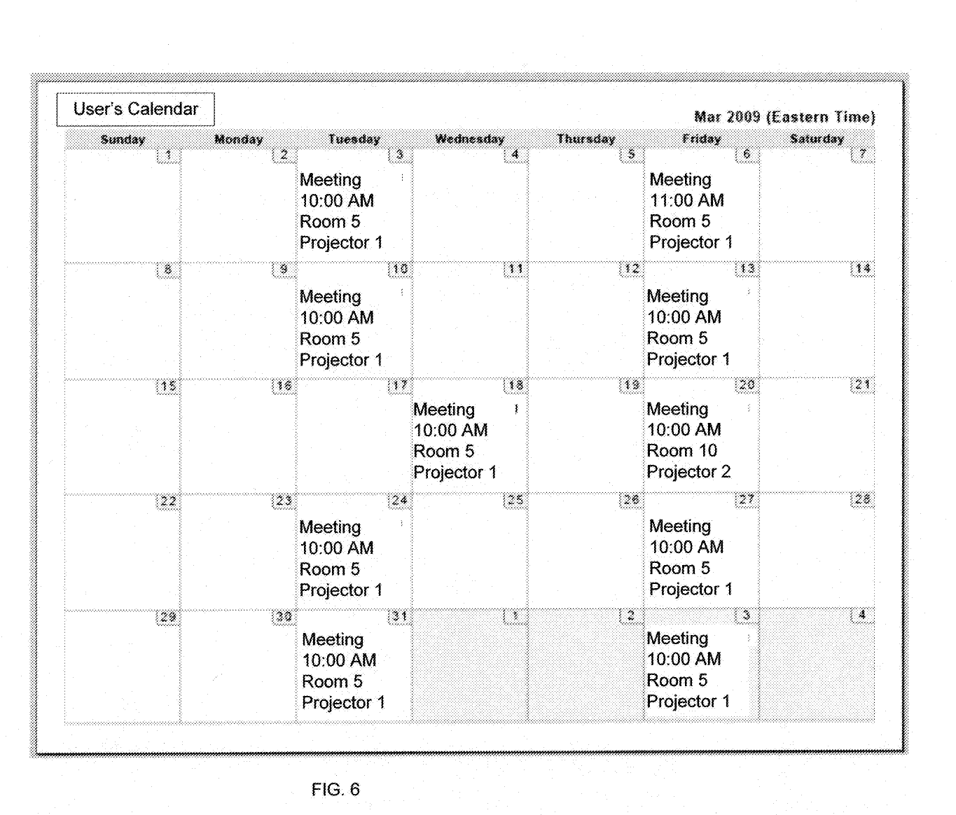

FIG. 6 shows an example of a recipient's calendar. In this example, calendar scheduling process 10 has sent 212 the modified repeated meeting event to the recipient and the modified repeated meeting event appears on the recipient's calendar. As shown, the individual meetings added on the recipient's calendar may reflect and include the modifications to the repeated meeting event made by the meeting chair and received 206 by calendar scheduling process 10. For example, the individual meeting on March 6 shows a time of 11:00, rather than 10:00; the fifth meeting in the series of individual meetings occurs on March 18, thus avoiding the holiday on March 17, and the meeting on March 20 utilizes room 10 and projector 2, rather than room 5 and projector 1.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The process, computer program, and system claimed may be used, for example, to send repeated meeting requests to recipients where the repeated meeting request requires customization. A number of embodiments have been described. However, the following claims define the scope of the invention.

What is claimed is:

1. A method for sending modified repeating meetings events comprising:
receiving a request to create a repeating meeting event on a calendar and scheduling computer system;
listing one or more instances of individual meetings of the repeating meeting event by the calendar and scheduling computer system;
receiving a request to modify at least one of the one or more instances of individual meetings by the calendar and scheduling computer system;
creating a modified repeating meeting event including one or more modified and unmodified instances of individual meetings by the calendar and scheduling computer system; and
sending the modified repeating meeting event to one or more recipients from the calendar and scheduling computer system.

2. The method of claim 1 further comprising displaying a customization button on a computer display, wherein activation of the customization button triggers the listing of the one or more instances of individual meetings.

3. The method of claim 1 wherein the request to modify at least one of the one or more instances of individual meetings includes a request to modify one or more of a date and time of the one or more instances of individual meetings.

4. The method of claim 1 wherein the request to modify at least one of the one or more instances of individual meetings includes a request to modify a resource associated with the one or more instances of individual meetings.

5. The method of claim 1 further comprising displaying a list of available resources associated with at least one of the instances of individual meetings, thus allowing a user to select one or more available resources from the list.

6. The method of claim 1 wherein listing the one or more instances of individual meetings includes displaying the one or more instances of individual meetings on a display, thus allowing a user to select one or more of the instances of individual meetings for modification.

7. A computer program product for sending modified repeating meetings events, residing on a computer readable medium, having a plurality of instructions stored thereon, which, when executed by a processor cause the processor to perform operations comprising:
receiving a request to create a repeating meeting event on a calendar and scheduling computer system;
listing one or more instances of individual meetings of the repeating meeting event by the calendar and scheduling computer system;
receiving a request to modify at least one of the one or more instances of individual meetings by the calendar and scheduling computer system;
creating a modified repeating meeting event including one or more modified and unmodified instances of individual meetings by the calendar and scheduling computer system; and
sending the modified repeating meeting event to one or more recipients from the calendar and scheduling computer system.

8. The computer program product of claim 7 wherein the operations further comprise displaying a customization button on a computer display, wherein activation of the customization button triggers the listing of the one or more instances of individual meetings.

9. The computer program product of claim 7 wherein the request to modify at least one of the one or more instances of individual meetings includes a request to modify one or more of a date and time of the one or more instances of individual meetings.

10. The computer program product of claim 7 wherein the request to modify at least one of the one or more instances of individual meetings includes a request to modify a resource associated with the one or more instances of individual meetings.

11. The computer program product of claim 7 wherein the operations further comprise displaying a list of available resources associated with at least one of the instances of individual meetings, thus allowing a user to select one or more available resources from the list.

12. The computer program product of claim 7 wherein listing the one or more instances of individual meetings includes displaying the one or more instances of individual meetings on a display, thus allowing a user to select one or more of the instances of individual meetings for modification.

13. A calendar and scheduling computer system for sending modified repeating meetings events comprising:
one or more processors;
one or more memories;
one or more software instruction sets stored on the one or more memories, which, when executed by the one or more processors, perform operations comprising:
receiving a request to create a repeating meeting event on the calendar and scheduling computer system;
listing one or more instances of individual meetings of the repeating meeting event by the calendar and scheduling computer system;
receiving a request to modify at least one of the one or more instances of individual meetings by the calendar and scheduling computer system;
creating a modified repeating meeting event including one or more modified and unmodified instances of individual meetings by the calendar and scheduling computer system; and
sending the modified repeating meeting event to one or more recipients from the calendar and scheduling computer system.

14. The system of claim 13 wherein the operations further comprise displaying a customization button on a computer display, wherein activation of the customization button triggers the listing of the one or more instances of individual meetings.

15. The system of claim 13 wherein the request to modify at least one of the one or more instances of individual meetings includes a request to modify one or more of a date and time of the one or more instances of individual meetings.

16. The system of claim 13 wherein the request to modify at least one of the one or more instances of individual meetings includes a request to modify a resource associated with the one or more instances of individual meetings.

17. The system of claim 13 wherein the operations further comprise displaying a list of available resources associated with at least one of the instances of individual meetings, thus allowing a user to select one or more available resources from the list.

18. The system of claim 13 wherein listing the one or more instances of individual meetings includes displaying the one or more instances of individual meetings on a display, thus allowing a user to select one or more of the instances of individual meetings for modification.
